(19) United States
(12) Patent Application Publication
(10) Pub. No.: US 2026/0347541 A1
(43) Pub. Date: Nov. 5, 2026

(54) POLYAMIDE COMPOSITIONS

(71) Applicant: CARGILL, INCORPORATED, Wayzata, MN (US)

(72) Inventors: Antony Graham Carmichael, Hessle, East Yorkshire, England (GB); Adam John Maltby, Leven, East Riding of Yorkshire (GB); Remco Benjamin van Triet, Reeuwijk (NL)

(73) Assignee: CARGILL, INCORPORATED, Wayzata, MN (US)

(21) Appl. No.: 19/484,622

(22) PCT Filed: May 16, 2024
(86) PCT No.: PCT/US2024/029712

§ 371 Date: Nov. 14, 2025

Related U.S. Application Data
(60) Provisional application No. 63/502,741, filed on May 17, 2023.

(51) Int. Cl. C08G 69/34; C08L 23/0807

(52) U.S. Cl. CPC C08G 69/34; C08L 23/0815; C08L 2203/16; C08L 2205/06

(57) ABSTRACT

This disclosure relates to a polyamide composition comprising a polyamide condensation polymer or polymers of a C32-C44 dimer diacid and a C2-C44 aliphatic diamine. The polyamide condensation polymers may be utilized a range of concentrations and with additional additives. Use of the condensation polymers described herein in polyolefin compositions assists in the prevention of surface defects when the polyolefin composition are processed into finished products.

### CROSS-REFERENCE TO RELATED APPLICATIONS

This application claims the benefit of U.S. Provisional Application No. 63/502,741, filed May 17, 2023, which is incorporated by reference herein in its entirety.

### TECHNICAL FIELD

This application relates to specific polyamide compositions that have been designed for use in manufacturing of finished polyolefin goods such as films.

### BACKGROUND

A polyolefin is a type of polymer with the general formula (CH₂CHR)ₙ where R is an alkyl group or a hydrogen. They are usually derived from a small set of simple olefins (alkenes). Dominant in a commercial sense are polyethylene and polypropylene. More specialized polyolefins include polyisobutylene and polymethylpentene. They are all colorless or white oils and solids. Many copolymers are known, such as polybutene, which derives from a mixture of different butene isomers. The name of each polyolefin indicates the olefin from which it is prepared; for example, polyethylene is derived from ethylene, and polymethylpentene is derived from 4-methyl-1-pentene. Polyolefins may be homopolymers, copolymers, random, or block copolymers.

To create finished products, a polyolefin composition is often heated to a molten state and extruded through a die to create a finished product such as a film. Linear Low Density Polyethylene (LLDPE) in one such example. A polymer melt, as a vicious system, does not flow easily or evenly through a die. Rather the material flowing near the surface of the die flows more slowly than the material nearer to the middle of the die opening. As the flow rate through the die is increased, this disparity increases until a point is reached where a surface defects become detectable at the die exit. The surface changes from smooth and glossy, to matt, and finally to rough. Eventually, surface of the extruded material will be deformed into what is termed in the art as a “sharkskin” effect. This is created by the flow transitioning to an irregular flow of slower and faster movement. The extrusion can we described as jerking or pulsing out of the die.

The sharkskin effect occurs at the die exit when shear rate is increased to a level that the center of the melt moves so fast that the material adhering to the wall exhibits a stick slip phenomenon. Sharkskin tends to be promoted by lower extrusion temperatures, narrower die gaps, high molecular weight (low MFI) polymers, lack of long chain branching and narrow molecular weight distributions. It is particularly prevalent in Linear Low Density Polyethylene (LLDPE) grades. LLDPE is a copolymer of ethylene and a short α-olefin such as 1-butene, 1-hexene, methyl pentene, or 1-octene.

To avoid this effect, manufacturers must make particular choices. They can operate the extrusion more slowly, or they can operate at higher temperatures. Both solutions, however, increase processing costs and are undesirable. Alternatively, fluoropolymers have been commonly added to polyolefin compositions to ameliorate this difficulty. Fluoropolymers, used as process aids, deposit at the die surfaces and smooth the transition from adhesion to slip, and delay the onset of surface defects to higher shear rates.

Unfortunately, use of fluoropolymers comes with a very significant drawbacks. Production and use of these materials has been linked to significant environmental impacts to human populations. In addition, fluoropolymers are extremely enduring materials and are not susceptible to biological breakdown. Once they enter the ecosystems of land, lakes, and sea; they are present for lifetimes. These materials are highly undesirable and are being increasingly regulated.

Polyolefin manufactures are keen to replace fluoropolymers additives with a solution that is sustainably sourced and avoids these serious environmental drawbacks.

### SUMMARY

The present disclosure provides alternative additives to polyolefin compositions that have the advantage of being biobased, more sustainable, and less impactful on the environment than existing solutions. The polyolefin compositions containing the polyamides described herein have the advantage of reduced haziness, improved gloss, and improved transparency compared to control compositions with little or no impact on output rate. Specially the materials described herein can be used to replace the functionality of fluoropolymers in polyolefin processing.

The present disclosure provides a polyolefin composition comprising greater than 100 ppm of a polyamide condensation polymer of a C32-C44 dimer diacid and a C2-C44 diamine.

The present disclosure further provides a polyolefin composition comprising a compound of Formula 1:

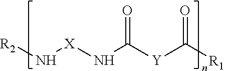

wherein:
X is a branched or linear aliphatic or aromatic group comprising 2-44 carbons,
Y is a branched or linear aliphatic or aromatic group comprising 30-44 carbons,
R₁ is hydroxyl, —OR₃, —NHXNH₂, or —NHXNHCOR₃,
R₂ is hydrogen, —COR₃, or —COYCOR₄,
R₃ is a C12-C22 alkyl,
R₄ is hydroxyl or C12-C22 alkoxy, and
n is a positive integer such that the average molecular weight (Mw) of the condensation polymer is from 3,000 to 100,000.

Polyolefin compositions without the polyamide additives disclosed herein may require higher processing temperatures and have reduced flow properties. This reduction in smooth flow through processing equipment leads to uneven retention time and localized overheating of the polymer compositions. This overheating can lead to undesired crosslinking of the polymer and gel formation that contributes to surface defects on the article being produced.

### BRIEF DESCRIPTION OF THE FIGURES

FIG. 1 is a depiction of the extrusion apparatus utilized in the Examples to prepare test samples for evaluation.

FIG. 2 is an expanded depiction of the apparatus of FIG. 1 describing the die size and monitoring features of the apparatus.

### DETAILED DESCRIPTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter. One aspect described in conjunction with a particular embodiment is not necessarily limited to that embodiment and can be practiced with any other embodiment(s).

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

As used herein, the singular forms “a,” “an,” and “the” and similar referents in the context of describing the elements (especially in the context of the following claims) include plural referents unless the context clearly dictates otherwise. For example, reference to “a substituent” encompasses a single substituent as well as two or more substituents, and the like. It is understood that any term in the singular may include its plural counterpart and vice versa, unless otherwise indicated herein or clearly contradicted by context.

The term “or” is used to refer to a nonexclusive “or” unless otherwise indicated. The statement “at least one of A and B” has the same meaning as “A, B, or A and B.”

In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Any publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

As used herein, the terms “for example,” “for instance,” “such as,” or “including” are meant to introduce examples that further clarify more general subject matter. Unless otherwise specified, these examples are provided only as an aid for understanding the applications illustrated in the present disclosure and are not meant to be limiting in any fashion.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. In some aspects, substantially means greater than 90% or between 90% ang 100%.

As used herein, the following terms have the following meanings unless expressly stated to the contrary.

The terms “esterification or esterified” means the creation of an ester bond including: 1) the dehydration reaction of an alcohol with an acid; 2) transesterification, the reaction of an alcohol with an ester to form a new ester; or 3) interesterification.

The term “Polydispersity Index” (also known as “Molecular Weight Distribution”) as used herein is the ratio of weight average molecular weight (Mw) to number average molecular weight (Mn). The polydispersity data is collected according to the following procedure.

The molecular weight of the materials disclosed herein was determined by well-known methods in the art for the analysis of polymers. GPC is a typical method where experimental samples are evaluated relative to a standard curve created by reference polystyrene benchmarks.

Samples for GPC were prepared as follows. Approximately +/−7.5 mg sample was weighed in a 2 ml LC vial. 750 μl THF was added and the vial capped. The sample was gently heated if needed to dissolve the sample. The vial was opened and 100 μl pyridine and 100 μl acetic anhydride added. The vial was capped and agitated for 10-20 sec. The mixture was allowed to react at 80° C. for 30 min. The vial was opened the solvent evaporated under N2 flow at 80° C. The residue was redissolved in +/−750 μl THF to a concentration of 10 mg/ml and this sample used for GPC analysis.

Standards were prepared as follows. Polystyrene low mix MW 570, 970, 2450, 5050, 11600, 28500, 660000; Polystyrene high mix MW 108000, 176000, 320000, 475000. For both standards 2-3 mg per standard were combined and dissolved in 10 ml of mobile phase (THF). The sample solution was filtered over a 0.45 μm PTFE filter and stored refrigerated at 4° C. in a clear vial capped with PTFE lined crimp cap.

GPC samples were run on the following conditions.

Instrumental parameters:

| Acquisition | PLgel 5 um 10000 A 1000 A 500 A | |
|---|---|---|
| method | 100 A 300 × 7.5 mm · amx | |
| Mobile phase | THF (LC grade) | |
| Degasser | Agilent 1200 | |
| Pump | Agilent 1200 | |
| Flow | 1 | ml/min |
| Injector | Agilent 1200 | |
| Injection volume | 10 | μl |
| Column oven | Agilent 1200 | |
| Oven temperature | 55 | °C |
| Guard column | PL gel guard, Length: 5 cm, i.d: 7.5 mm | |
| Particle size | 5 | μm |
| Columns | PL gel 10000 Å, Length: 30 cm, i.d: 7.5 mm | |
| | PL gel 1000 Å, Length: 30 cm, i.d: 7.5 mm | |
| | PL gel 500 Å, Length: 30 cm, i.d: 7.5 mm | |
| | PL gel 100 Å, Length: 30 cm, i.d: 7.5 mm | |
| Particle size | 5 | μm |
| Detector | Agilent 1200 RID | |
| Detector | 55 | °C |
| temperature | | |
| Run time | 45 | minutes |

Molecular weight data was determined by comparison to the set of polystyrene standards.

The term “weight average molecular weight” as used herein refers to M_{w}, which is equal to ΣMᵢ²nᵢ/ΣMᵢnᵢ, where nᵢ is the number of molecules of molecular weight Mᵢ. In various examples, the weight-average molecular weight can be determined using the test described herein or through size exclusion chromatography, light scattering, small angle neutron scattering, X-ray scattering, and sedimentation velocity.

The term “number average molecular weight” as used herein refers to Mₙ, which is equal to the total weight of the sample divided by the number of molecules in the sample. Mₙ, can be represented by the formula ΣMᵢnᵢ/nᵢ, where nᵢ is the number of molecules of molecular weight Mᵢ.

The term “Acid Value” (AV) as used herein is defined as the weight of KOH in mg needed to neutralize the organic acids present in 1 g of test sample and it is a measure of the free fatty acids present in the composition. AV can be determined by the AOCS Official Method Cd 3d-63.

The term “Amine Value” (AmV) as used herein is defined as the weight of KOH in mg needed to neutralize the free amine present in 1 g of test sample and it is a measure of the amines present in the composition. The amine value is defined as the number of mg of potassium hydroxide required to neutralize the free fatty acids in 1 g of sample and was measured by direct titration with a standard hydrochloric acid. AmV can be determined by the AOCS Official Method Ca 5a-40.

The terms C₂-C₄₄ alkyl; C₂-C₃₆ alkyl, C₂-C₁₂; C₄-C₈; C₆-C₁₂; and C₁-C₁₀ alkyl means alkyl groups containing 1-36, 2-12, 4-8, and 1-10 carbons. Any similar numerical ranges should be considered likewise. In some aspects, alkyl groups may be branched. In other aspects, alkyl groups may be unbranched or straight. In other aspects, the alkyl groups may be a mixture of branched or unbranched. In other aspects, the alkyl groups may be a cyclic or aromatic or unbranched. One or more of the alkyl groups may be saturated, unsaturated, or a mixture there of. In other aspects, the alkyl groups may substituted, unsubstituted, or a mixture.

Polyethylenes can be homopolymers of ethylene or random copolymers of ethylene and an alpha olefin. Varying the amount of alpha olefin varies the amount of branching which in turn will have an effect on density. For typical products there is a continuum between around 0.88 to 0.97 g/cm³. It is common to refer to Pes<0.91 g/cm³ as VLLDPE (Very Low Linear) sometimes aka “Plastomers”, 0.91-0.93 is referred to as LLDPE (Linear Low), 0.93-0.945 as LMDPE (Linear Medium) and >0.945 as HDPE (High Density) polyethylene.

### Polycondensation Composition

The polyamide compositions described comprise a polycondensation product of a C₃₆-C₄₄ dimer diacid and a C₂-C₄₄ diamines.

The diamine may be any C₂-C₄₄ branched, cyclic, aromatic, or linear diamine such ethylene diamine, propylene diamine, hexamethylene diamine, and the like. In some aspects, the diamine is a C₂-C₁₂ aliphatic diamine. In some aspects, the diamine is a C₄-C₈ aliphatic diamine. In some aspects, the diamine is hexamethylene diamine. In some aspects, the diamine may be a mixture of diamines.

The dimer diacids (also referred to herein as dimer acids) are well known in the art and are produced by bimolecular polymerization of an unsaturated fatty acid such as oleic acid or linoleic acid, a drying oil fatty acid or a semi-drying oil fatty acid, or a lower monoalcohol ester of these fatty acids in the presence or absence of a catalyst. Dimer fatty acids are described in T. E. Breuer, ‘Dimer Acids’, in J. I. Kroschwitz (ed.), Kirk-Othmer Encyclopedia of Chemical Technology, 4th Ed., Wily, New York, 1993, Vol. 8, pp. 223-237. In general, the dimer acid is obtained as a mixture of an unreacted monomer, a dimer as a main component, and other high order polymers. If desired, the dimer acid component may be highly concentrated by proper fractionation means such as vacuum distillation or a solvent extraction process. In addition, to reduce the degree of unsaturation, polymerized fatty acids may be hydrogenated before or after the fractionation so as to produce a saturated dimer acid for use. The dimer acid may be aliphatic, cyclic, aromatic, or a mixture thereof.

Depending on the dimerization conditions and the starting materials one or more of the following structures are typically present in the dimer acid composition. In these structures R and R′ and alkyl groups.

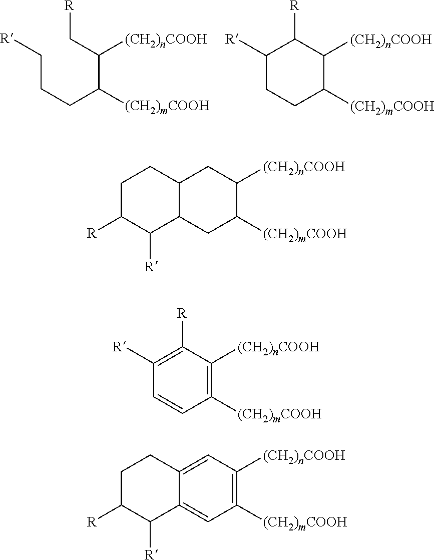

A commercially available dimer acid may be used, including, for example, Pripol 1017, Pripol 1022, Pripol 1029, Pripol 1012, Pripol 1013, Pripol 1014, Pripol 1025, Pripol 1027, Pripol 1006, Pripol 1009, and Pripol 1010 made by Cargill Incorporated, and Tsunodime 216 and Tsunodime 395 made by Tsuno Co., Ltd. One kind of dimer acid may be singly used, or two or more kinds of dimer acids may used in combination. In some aspects, one kind or two or more kinds of these in combination are selected from Pripol 1012, Pripol 1013, Pripol 1014, Pripol 1006, Pripol 1010, and Tsunodime 395.

In some aspects, the dimer diacid is represented by the formula HO₂CYCO₂H where Y is a C₃₀-C₄₂ aliphatic or aromatic carbon group.

In some aspects, the dimer diacid is represented by the formula HO₂CYCO₂H where Y is a C₃₄ aliphatic or aromatic carbon group.

In some aspects, the dimer acid is a C₃₆ dimer acid. In some aspects, the dimer acid is Pripol 1006.

In some aspects, the diacid comprises a dimer acid and an additional diacid. Among the additional diacid components other than the dimer acid, examples of the dicarboxylic acid include oxalic acid, malonic acid, succinic acid, glutaric acid, adipic acid, pimelic acid, suberic acid, azelaic acid, sebacic acid, nonamethylenedicarboxylic acid, decamethylenedicarboxylic acid, undecamethylenedicarboxylic acid, dodecamethylenedicarboxylic acid, tridecamethylenedicarboxylic acid, tetradecamethylenedicarboxylic acid, pentadecamethylenedicarboxylic acid, hexadecamethylenedicarboxylic acid, maleic acid, fumaric acid, phthalic acid, terephthalic acid, 1,3-, or 1,4 cyclohexanedicarboxylic acid, 1,3-adamantanedicarboxylic acid, and mixtures thereof. These additional diacids may be used singly or in combinations of two or more.

In some aspects, the additional diacid is selected from the group consisting of adipic acid, glutaric acid, pimelic acid, suberic acid, azelaic acid, sebacic acid and mixtures thereof.

In another aspect, the polyamide composition comprises a condensation polymer or polymers of the Formula 1:

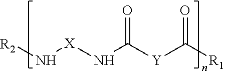

wherein:
X is a branched or linear aliphatic or aromatic group comprising 2-44 carbons,
Y is a branched or linear aliphatic or aromatic group comprising 30-44 carbons,
R₁ is hydroxyl or —NHXNH₂,
R₂ is hydrogen or —COYCOR₄,
R₄ is hydroxyl or C12-C22 alkoxy, and
n is a positive integer such that the average molecular weight (Mw) of the condensation polymer is from 3,000 to 100,000.

In some aspects, X is an aliphatic group comprising 4-8 carbons.

In some aspects, X is an aliphatic group comprising 6 carbons.

In some aspects, Y is a 32-40 carbon, or 34 carbon group.

In some aspects, Y is a 34 carbon group.

In some aspects, R₁ is hydroxyl.

In some aspects, R₁ is —NHXNH₂.

In some aspects, R₂ is hydrogen.

In some aspects, R₁ is —NHXNH₂ and R₂ is hydrogen.

In some aspects, R₁ is hydroxyl and R₂ is hydrogen.

In some aspects, R₂ is hydrogen.

In some aspects, R₁ is hydroxyl and R₂ is hydrogen.

In some aspects, average molecular weight (Mw) of the condensation polymer is from 30,000 to 75,000.

In some aspects, the polyamide polymer is molten or substantially softened between 65° C. and 120° C.

In some aspects, the polyamide polymer or compound of Formula 1 has an amine value of at least 2 mg KOH/g.

In some aspects, the polyamide polymer or compound of Formula 1 has an amine value of between 2 mg KOH/g and 10 mg KOH/g.

In some aspects, the polyamide product or compound of Formula 1 will have an acid value of <1 mg KOH/g and/or an amine value between greater than 2 mg KOH/g. In some aspects, the polyamide product or compound of Formula 1 will have an acid value of between 0.1 and 1 mg KOH/g and/or an amine value between 1 and 10 mg KOH/g. In some aspects, the polyamide product or compound of Formula 1 will have an acid value of between 0.1 and 1 mg KOH/g and/or an amine value between 2 and 10 mg KOH/g. In some aspects, the polyamide product or compound of Formula 1 will have an acid value of between 0.1 and 1 mg KOH/g and/or an amine value between 3 and 7 mg KOH/g.

### Method of Preparing Polyamide Compositions

Typically, the dimer diacid (and other diacid if utilized) and diamine(s) are mixed together at elevated temperature optionally in the presence of a catalyst with removal of water. This reaction is well known in the art. The dimer acid is heated to approximately 60° C. under an inert atmosphere (optionally in the presence of between 0.05 and 0.5 w/w % of a catalyst such as sodium hypophosphite, phosphoric acid, phosphorous acid, triphenylphosphite, TBT, stannous oxide, and the like) and the diamine added slowly in a controlled fashion. The reaction is then heated slowly to a temperature of approximately 220° C.-250° C. until a desired endpoint of acid value and/or amine value is reached. The reaction is cooled, and the polyamide product is isolated.

A skilled artisan will appreciate that the polycondensation described herein will yield a mixture of products. Molecules of varying chain lengths will exist as well as chains terminated by: i) an amine group and an acid group, ii) two amine groups, or iii) two acid groups. Depending on the stoichiometry of the dimer acid and diamine, the resulting products may have more of one type of terminal group than the other. In some aspects, the diamine is utilized in 3-10% molar excess to yield predominantly amine end capped products. In addition, depending on the duration, temperature, and catalyst the extent of polymerization can be varied such that differing molecular weights are achieved.

In some aspects, the ratio of dimer diacid to diamine is between 1.5/1.0 and 1.0/1.5. In other aspects, the ratio of dimer diacid to diamine is between 1.3/1.0 and 1.0/1.3. In other aspects, the ratio of dimer diacid to diamine is between 1/1 and 1.0/1.3.

These end groups may be further reacted or “capped”. Amine end groups may be capped by addition of a mono-acid such as a fatty acid. Acid end groups may be capped by reaction with a mono-amine, diamine, or an C₁₂-C₂₂ aliphatic alcohol. These endcapping reactions may be be performed after the completion of the polycondensation reaction or also performed in situ by adding the mono-acid, mono-amine, or alcohol to the poly condensation reaction mixture. In some aspects, the polyamide may be endcapped with a C₈-C₂₂ fatty acid. In some aspects, the polyamide may be endcapped with a C₂-C₂₂ aliphatic amine. In some aspects, the polyamide may be endcapped with a C₈-C₂₂ fatty acid or with a C₂-C₁₂ aliphatic amine.

In some aspects, the polyamide polymers or compounds of Formula 1 will have a molecular number average (Mn) of at least 3,000 Daltons. In some aspects, the polyamide polymers or compounds of Formula 1 will have a molecular number average (Mn) of at least 5,000 Daltons. In some aspects, the polyamide polymers or compounds of Formula 1 will have a molecular number average (Mn) of between 3,000 and 100,000 Daltons. In some aspects, the polyamide polymers or compounds of Formula 1 will have a molecular number average (Mn) of between 4,000 and 15,000 Daltons. In some aspects, the polyamide polymers or compounds of Formula 1 will have a molecular weight average (Mw) of at least 20,000 Daltons. In some aspects, the polyamide polymers or compounds of Formula 1 will have a molecular weight average (Mw) of between 5,000 and 80,000 Daltons. In some aspects, the polyamide polymers or compounds of Formula 1 will have a molecular weight average (Mw) of between 30,000 and 70,000 Daltons.

Any and every combination of two or more features disclosed herein for the natural oil-based petrolatums has been specifically contemplated and envisioned by the inventors. Therefore, the inventors have conceived of, and accordingly disclosed, every combination of single points and ranges disclosed for the parameters described herein.

### Polyolefins

A polyolefin is a type of polymer with the general formula (CH₂CHR)ₙ where R is an alkyl group or hydrogen. They are usually derived from a small set of simple olefins (alkenes). Dominant in a commercial sense are polyethylene and polypropylene. More specialized polyolefins include polyisobutylene and polymethylpentene. The name of each polyolefin indicates the olefin from which it is prepared; for example, polyethylene is derived from ethylene, and polymethylpentene is derived from 4-methyl-1-pentene. Polyolefins are not olefins themselves because the double bond of each olefin monomer is opened in order to form the polymer. Monomers having more than one double bond such as butadiene and isoprene yield polymers that contain double bonds (polybutadiene and polyisoprene), for the purposes of this disclosure, will be considered polyolefins. They may be purchased from a wide variety of industrial producers. For example, LLDPE may be purchased under the Clearflex® brand from Versalis.

Examples of polyolefins include but are not limited to the following low-density polyethylene (LDPE), linear low-density polyethylene (LLDPE), very-low-density polyethylene (VLDPE), ultra-low-density polyethylene (ULDPE), medium-density polyethylene (MDPE), polypropylene (PP), polymethylpentene (PMP), polybutene-1 (PB-1); ethylene-octene copolymers, stereo-block PP, olefin block copolymers, and propylene-butane copolymers.

### Method of Preparing Polyolefin Compositions

Polyolefin compositions of the present disclosure can be prepared by any method known in the art for combining polymer additives into a resin composition to be extruded. For example, methods include but are not limited to the following: the polyamides may be blended with the polyolefin, coated onto the polyolefin, co-injected into an extruder at an appropriate dosage, or prepared in a master batch. Method of preparation of the polyolefin is not critical and those skilled in the art employing additives similar to the polyamides of the present disclosure will choose among these and other methods depending upon their particular circumstances.

Polyolefin compositions may further comprise any additional additive desired by the ultimate user including uv protectants, antioxidants, colorants, plasticizers, antiblocking, agents, slip agents, and the like.

In some aspects, the polyolefin is a polyethylene or polypropylene.

In some aspects, the polyolefin is a polyethylene or a low density polyethylene.

In some aspects, the polyolefin is a linear low density polyethylene.

In some aspects, the polyolefin will comprise greater than 100 ppm of the polyamide condensation product or product of Formula 1 disclosed herein.

In some aspects, the polyolefin will comprise between 200 ppm and 3000 ppm of the polyamide condensation product or product of Formula 1 disclosed herein. In some aspects, the polyolefin will comprise between 200 ppm and 1500 ppm of the polyamide condensation product or product of Formula 1 disclosed herein.

In some aspects, the polyolefin composition is a master batch which contains between 5% and 25% by weight of the polyamide condensation product or product of Formula 1 disclosed herein.

### EXAMPLES

TABLE 1

| Materials | Source |
|---|---|
| Pripol 1006 (Dimer diacid) | Cargill |
| Hexamethylene diamine | Aldrich/Merck |
| Stearic Acid | KLK Oleo |
| Crystasense LP | Croda |

### Examples 1A-F

A 500 ml 4-necked round-bottomed flask equipped with a magnetic stirrer with a metal propeller stirrer, temperature feedback probe, a nitrogen sparge inlet and a condenser with receiver flask was charged with Pripol 1006 (213.72 g, 0.375 mol; 0.75 equiv.) and the content was heated to 60° C. under atmospheric pressure with N2 purge through the mixture, with stirring (150-200 rpm).

At 60° C., hexamethylene diamine (HMDA); (46.28 g, 0.40 mol; 0.80 equiv.) was slowly dosed over 30 minutes and the temperature was allowed to rise. Prior to dosing HMDA, the nitrogen sparge inlet was removed out of the liquid and nitrogen was allowed to sparge through the headspace.

The mixture was then heated to between 160-170° C. at which significant foaming occurs, water distillation as side product begins to occur. At this stage heat input was reduced to control temperature and stirring was slowed to 50 rpm. At 190° C. foaming dissipated, nitrogen was sparged through the liquid, the mixture was heated to approximately 230° C., and stirrer speed increased to 150-200 rpm.

Reaction conditions were maintained until the desired specifications (acid value<1 mg KOH/g, amine value<10 mg KOH/g) were reached, approximately 3 to 4 hours at reaction temperature. The mixture was cooled down to 200° C. and 0.1 w/w % of Irganox 1010 and Irgafos 168 were dosed and allowed to mix for 15 minutes. Finally, the mixture was poured out at 200° C. in a non-coated metal pan and allowed to cool.

Example 1B was a repeat experiment in which stearic acid was added at the beginning of the reaction to endcap the polyamide.

Example 1C was a repeat experiment but with different stoichiometry to obtain an acid ended polyamide with lower amine value and higher acid value.

Example 1D is a repeat of 1A with different stoichiometry to yield a short(er) chain amine ended polyamide.

Example 1E is a repeat of 1B with different stoichiometry to obtain an amine terminated polyamide with a higher amine value.

Example 1F is a repeat of 1C with different stoichiometry to give an even higher acid value and shorter chain length.

Examples 1G and 1H are repeats of including stearic acid to create short(er) stearyl endcapped polyamide or a partial stearyl endcapped polyamides.

TABLE 2
weights, mol ratio and wet chemistry analyses for Examples 1A-F

| | Pripol | HMDA | Molar ratio | Stearic | Acid value | Amine value |
|---|---|---|---|---|---|---|
| Example | 1006 (g) | (g) | 1006/HMDA | acid (g) | (mg KOH/g) | (mg KOH/g) |
| 1A | 213.72 | 46.18 | 1:1.070 | | 0.00 | 7.71 |
| 1B | 202.81 | 43.91 | 1:1.070:0.131 | 13.27 | 0.91 | 0.91 |
| 1C | 232.77 | 43.13 | 1:0.92 | | 16.57 | 0 |
| 1D | 222.50 | 43.13 | 1:0.96 | | 9.17 | 0.96 |
| 1E | 206.54 | 53.46 | 1:1.280 | | 0.00 | 34.88 |
| 1F | 224.42 | 35.58 | 1:0.78 | | 40.2 | 0.00 |
| 1G | 170.52 | 44.14 | 1:1.279:0.534 | 45.34 | 1.68 | 1.16 |
| 1H | 208.51 | 45.15 | 1:1.070:0.061 | 6.34 | 0.00 | 2.02 |

TABLE 3
GPC molecular weight averages (versus polystyrene standard)

| Example | Mn(Da) | Mw(Da) |
|---|---|---|
| 1A | 12872 | 53330 |
| 1B | 9012 | 26903 |
| 1C | 7920 | 26368 |
| 1D | 10560 | 34063 |
| 1E | 4923 | 11536 |
| 1F | 4191 | 11694 |
| 1G | 4333 | 8188 |
| 1H | 12987 | 42373 |

### Example 2

Sharkskin and melt fracture in a cast film can be assessed in small scale processing equipment as long as a suitable shear rate can be produced. A Haake Rheocord system was utilized. which is essentially a high instrumented polymer processing system. This system was configured in extrusion mode with a small single screw extruder, feeding into a slit capillary die fitted with temperature and pressure transducers allowing the measurement of pressure drop along the die length. This along with output rate measurements allows the rheological properties of the polymer to be evaluated.

To screen the polymeric processing aids in this work it was sufficient to carry out a visual observation of the transparency and smoothness of the extruded strip. However, for completeness the torque, motor power consumption, output rate and die pressure drop can also be recorded. The output and die pressure can be used to calculate apparent shear rate, shear stress, and apparent viscosity.

Example 2A was prepared by dissolving (1.1 g) of the polyamide of Example 1A in 500 ml of solvent (Industrial methylated spirit, cyclohexane, or a blend of the two as needed) in a 11 Duran bottle and agitated to dissolve with heating if required. 125 ml of this solution was added to LLDPE (250 g) in a 11 round bottomed flask. The solvent was removed on a rotary evaporator until no solvent was observed distilling off. The flask was removed from the rotary evaporator and with agitation the pellets were discharged into an aluminum foil tray. This was repeated a further 3 times to give 1 kg of sample. The additional 0.1 g was used to account for losses on the surface of the apparatus to yield a polyolefin compositions comprising approximately 1000 ppm of polyamide processing aid.

Example 2B was prepared in a similar fashion to Example 2A with the exception that the processing aid was Crystasense LP3 commercially available from Croda. Crystasence LP3 is polyamide compositions derived from the polycondensation of a C36 dimer acid and ethylene diamine that is further end capped with stearic acid.

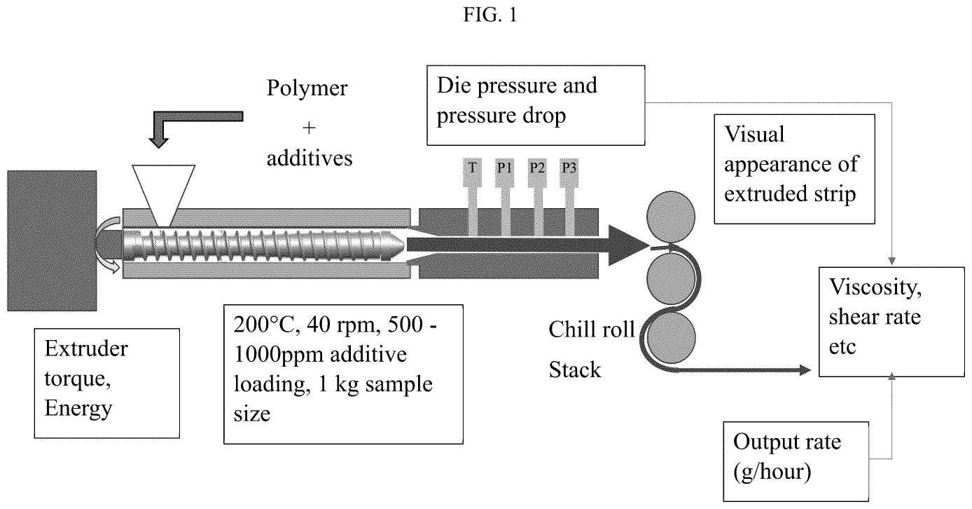

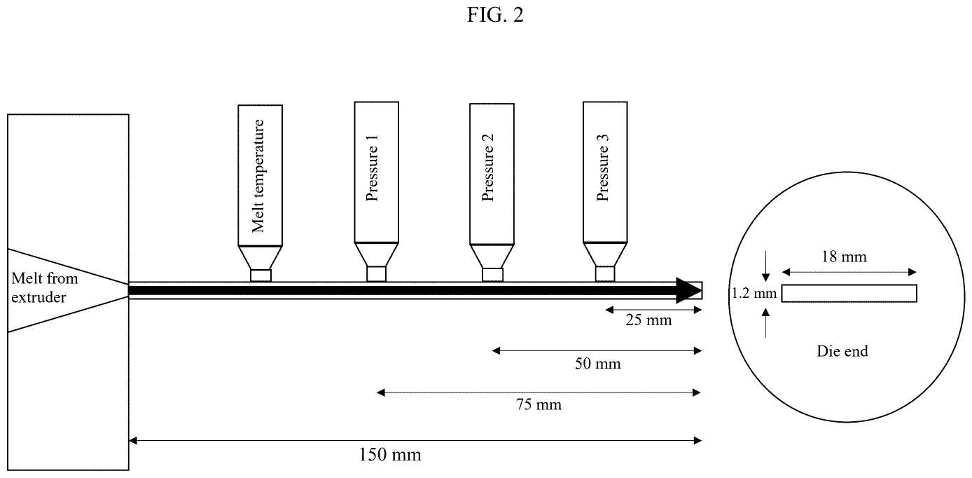

Examples 2A and 2B were compared to a LLDPE sample containing a fluoropolymer processing additive (at 300 ppm to 1000 ppm) under identical extrusion conditions. The resulting polymer+additive blends and controls were extruded on the Haake Rheocord [QC fitted with a 19/25 QC-B single screw extruder and a slit capillary die (L150 mm×W18 mm×H1.2 mm)] as set out in FIGS. 1 and 2 with the parameters set out in Table 4.

TABLE 4

| Speed (rpm) | Zone 1 (°C) | Zone 2 (°C) | Zone 3 (°C) | Die (°C) |
|---|---|---|---|---|
| 40 | 195 | 195 | 200 | 200 |

Each run is carried out as follows. The extrudate was fed onto the chill rollers (15° C.) running at a speed setting of 100. Control material was run until stable torque, pressure and temperatures are achieved. The level of polymer in feed throat was allowed to run out until the top of the screw can be seen. Test sample (1 kg) was added to the feed hopper. Samples were collected when conditions re-stabilized (Torque and pressure may change to a new stable level and was recorded). When approximately ⅔ of the polymer was consumed (750 g) the strip was observed for evidence of change in appearance.

Samples can be visually evaluated by the degree of haze, clarity, and presence of surface defects. Control samples with no additives yielded poor films with a high degree of haze and surface defects. Control samples with fluoropolymer processing additives (FPPA) showed improvement over the base control but still showed a significant degree of haze and defects. Both Examples 2A and 2B were dramatically better performing than the control and the FPPA material. Both clarity and surface quality of the samples was significantly belier.

The analysis was also repeated using laboratory scale blown film equipment and similar results were achieved. The Examples 2A and 2B yielded films with much belier clarity and fewer surface defects than either the base control or control containing FPPA.

### Example 3

A variety of diamines (shown in Table 5) were utilized in the preparation of polyamides with dimer acid according to the procedure of Example 1. Diamines were added to the reaction (1,8-octanediamine was 50% by weight solutions in water). Stirring and heating were carefully managed to control foaming. Stoichiometry and analytical data is presented below in Table 6. The evaluation protocol of Example 2 was repeated with samples 3A-G formulated in LLDPE (Clearflex FF106A from Versalis) at 500 ppm inclusion level through use of a master batch. All of the samples greatly improved clarity and sharkskin compared to control.

TABLE 5

| Diamine | Background info | Structure |
|---|---|---|
| Example 3A IPDA (isophorone diamine) | CAS: 2855-13-2 Mw: 170.3 g/mol Bp: 247 ºC | 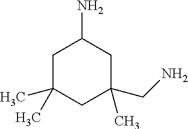 |
| Example 3B TMD (Trimethyl hexamethylene diamine) | CAS: 25620-58-0 Mw: 158.28 g/mol Bp: 232 °C | 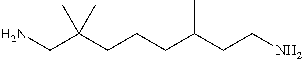 |
| Example 3C (dimer diamine) Cargill Incorporated | CAS: 62647-35-2 Mw: 536.8 g/mol Bp: >250 °C | 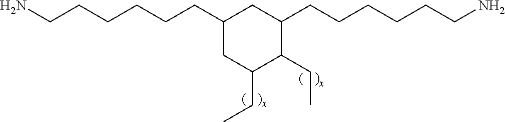 |
| | | x = 6/7/8 |
| Example 3D 4,4-oxydianaline | CAS: 100-80-4 Mw: 200.24 g/mol Bp: >250 °C | 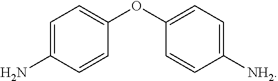 [SMILES: Nc1ccc(Oc2ccc(N)cc2)cc1] |
| Example 3E 1,8-octanediamine | CAS: 373-44-4 Mw: 144.26 g/mol Bp: 225 ºC | 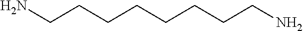 |
| Example 3F 1,3 propanediamine | CAS: 109-76-2 Mw: 74.12 g/mol | 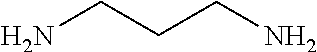 |
| | Bp: 140 °C | |
| Example 3G (TCD diamine) | CAS: 129680-22-4 Mw: 194.32 g/mol Bp: 287 °C | 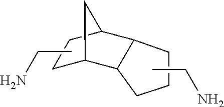 |

TABLE 6

| | | | Molar | Acid | Amine | | |
|---|---|---|---|---|---|---|---|
| | | | ratio | value | value | | |
| | Pripol | Diamine | 1006/ | (mg | (mg | Mn | Mw |
| Ex. | 1006 (g) | (g) | diamine | KOH/g) | KOH/g) | (Da) | (Da) |
| 3A | 197.58 | 62.42 | 1:1.065 | 0.26 | 8.51 | 5848 | 13054 |
| 3B | 200.92 | 59.48 | 1:1.074 | 0.00 | 6.61 | 7236 | 19077 |
| 3C | 129.23 | 130.77 | 1:1.083 | 0.44 | 5.37 | 7327 | 19650 |
| 3D | 189.53 | 70.47 | 1:1.066 | 2.36 | 0.66 | 2927 | 11089 |
| 3E | 205.24 | 109.52 * | 1:1.062 | 0.95 | 5.48 | 3826 | 9775 |
| 3F | 208.61 | 31.39 | 1:1.166 | 0.53 | 8.01 | 4961 | 13746 |
| 3G | 191.02 | 68.98 | 1:1.066 | 0.00 | 7.81 | 3878 | 9838 |

*as a 50% weight solution

### Example 4

The evaluation of Example 2 was repeated with samples 1A-H formulated in LLDPE (Clearflex FF106A from Versalis) at 500 ppm inclusion level through use of a master batch. The were prepared in a standard fashion by extruding on Prism twin screw extruder at 210° C. and were pelletized. Output rate was measure and clarity observed. Samples were evaluated after 60 minutes of extrusion. Some samples improved clarity earlier in the run but comparisons were made at 60 min. It appears from Table 7 that compositions with a higher amine value may be preferred. In addition, acid endcapping may not be advantageous in some circumstances.

TABLE 7

| | | Output | |
|---|---|---|---|
| | Formulation | (g/10 | |
| Example | @ 500 PPM | min) | Observations |
| | Control | 130.16 | Poor clarity. ‘Shark-skin’ is |
| | blank | | demonstrated well |
| 4A | 1A | 127.21 | Good clarity and output |
| 4B | 1B | 118.14 | Good clarity, but output affected |
| | | | significantly |
| 4C | 1C | 121.35 | Good on clarity, but output |
| | | | affected |
| 4D | 1D | 123.74 | Good clarity. Output similar to |
| | | | control |
| 4E | 1E | 129.41 | Poor clarity but better than the |
| | | | control. Output similar to control. |
| 4F | 1F | 118.50 | Very good clarity, but output |
| | | | affected. |
| 4G | 1G | 108.19 | Good on clarity but output more |
| | | | affected. |
| 4H | 1H | 123.50 | Good clarity and output |

### Example 5

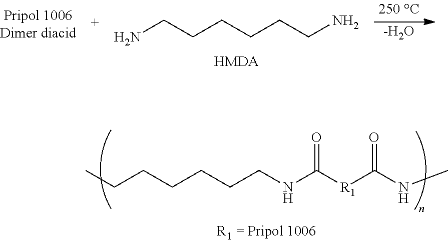

Example 1A (reaction above) was scaled up to 25 kg scale and repeated as set out below in Table 8. The monomers (HMDA and Pripol 1006) were heated at 60° C. in an oven for 6-8 hours to become molten. The reactor was heated to 60° C. before loading the dimer acid. The dimer was stirred at 100-150 rpm with nitrogen sparging through headspace. Molten HMDA was added in a controlled way and exotherm monitored. Once foaming is reduced and distillation rate slows down, nitrogen sparging was continued, preferably through the mixture (to allow better removal of water), and the temperature increased to 230° C.-250° C. internal temperature. The reaction was monitored by AV and Amine Value until AV was <1 mg KOH/g and Amine Value was approximately 7 mg KOH/g. The reactor was cooled to 200° C.-220° C. and discharged through the bottom valve into a water bath to obtain a polymer strand. The strand was pulled with the help of a belt conveyor and finally conveyed to a strand pelletizer where it was cut into pellets. Finally, the obtained pellets were dried in an air circulating oven to remove residual moisture coming from the water bath and bagged in aluminum foil bags.

TABLE 8

| | Pripol | HMDA | Molar ratio | Acid value | Amine value | | |
|---|---|---|---|---|---|---|---|
| Ex | 1006 (kg) | (kg)* | 1006/HMDA | (mg KOH/g) | (mg KOH/g) | Mn | Mw |
| 5A | 20.55 | 4.39 (98%) | 1:1.057 | 0.31 | 8.83 | 10836 | 37789 |
| 5B | 20.55 | 4.32 (99.5%) | 1:1.041 | 0.00 | 2.68 | 13944 | 65678 |
| 5C** | 20.55 | 4.35 (99.5%) | 1:1.048 | 6.90 | 0.56 | 9337 | 41260 |
| 5D | 20.55 | 4.39 (99.5%) | 1:1.057 | 0.20 | 2.73 | 7840 | 62822 |
| 5E | 20.55 | 4.45 (99.5%) | 1:1.073 | 0.31 | 3.62 | 10003 | 61030 |
| 5F | 20.55 | 4.45 (99.5%) | 1:1.073 | 0.22 | 3.09 | 9289 | 61634 |
| 5G | 20.60 | 4.40 (99.5%) | 1:1.058 | 0.18 | 3.28 | 12616 | 51735 |
| 5H | 20.59 | 4.41 (99.5%) | 1:1.058 | | | | |
| Bag 1 | | | | 0 | 6.22 | 9750 | 48880 |
| Bag 4 | | | | 0 | 6.17 | 9614 | 50396 |

*Purity of HMDA is included as (98% or 99.5%)
**Example 5C Experienced some difficultly during HMDA addition and during reaction that led to atypical result.

1. A polyamide composition comprising a condensation polymer of a C32-C44 dimer diacid and a C2-C44 diamine wherein the condensation polymer has an amine value of greater than 2 and a M_{w} between 5000 and 80,000 Daltons.

2. The polyamide composition of claim 1 comprising greater than 90% by weight of the condensation polymer.

3. The polyamide composition of claim 1 wherein the molar ratio of dimer diacid to diamine is between 1/1 and 1.0/1.5.

4. The polyamide composition of claim 1 wherein the dimer diacid is a C36 dimer diacid and the diamine is a C4-C8 diamine.

5. The polyamide composition of claim 4 wherein the diamine is 1,6-hexamethylene diamine.

6. The polyamide composition of claim 1 wherein the condensation polymer has an Mw Mw of between 30,000 and 70,000 Daltons.

7. The polyamide composition of claim 1 wherein the polyamide condensation polymer has an amine value of between 3 and 7.

8. The polyamide composition of claim 7 wherein the polyamide condensation polymer has an amine value of between 3 and 7 and an acid value less than 1.

9. A polyamide composition comprising a condensation polymer of the Formula 1: 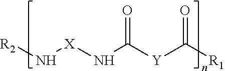
wherein:
X is a group comprising 2-44 carbons,
Y is a branched or linear aliphatic or aromatic group comprising 30-44 carbons,
R₁ is hydroxyl or —NHXNH₂,
R₂ is hydrogen or —COYCOR₄,
R₄ is hydroxyl or C12-C22 alkoxy, and
n is a positive integer such that the M_{w} of the condensation polymer is from 3,000 to 100,000 and wherein the condensation polymer has an amine value of greater than 2.

10. The polyamide composition of claim 9 wherein X is group comprising 2-12 carbons.

11. The polyamide composition of claim 10 wherein X is group comprising 4-8 carbons.

12. The polyamide composition of claim 11 wherein X is group comprises 6 carbons.

13. The polyamide composition of claim 9 wherein Y is group comprising 36 carbons.

14. The polyamide composition of claim 9 wherein R₂ is hydrogen and R₁ is NHXNH₂.

15. The polyamide composition of claim 9 wherein the polyamide condensation polymer has an Mw of at least 5,000 Daltons or between 5000 and 80,000 Daltons.

16. The polyamide composition of claim 15 wherein the polyamide condensation polymer has an Mw of between 30,000 and 70,000 Daltons.

17. (canceled)

18. The polyamide composition of claim 9 wherein the polyamide condensation polymer has an amine value of between 3 and 7.

19. The polyamide composition of claim 9 wherein the polyamide condensation polymer has an amine value of between 3 and 7 and an acid value less than 1.
